(19) United States
(12) Patent Application Publication
(10) Pub. No.: US 2008/0062495 A1
(43) Pub. Date: Mar. 13, 2008

(54) LASER SCANNING UNIT AND IMAGE FORMING APPARATUS HAVING THE SAME

(75) Inventor: Jong-wuk KU, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/689,625

(22) Filed: Mar. 22, 2007

(30) Foreign Application Priority Data
Sep. 11, 2006 (KR) 2006-87674
Oct. 27, 2006 (KR) 2006-104983

(51) Int. Cl. G02B 26/08

(52) U.S. Cl. 359/216; 359/206

(57) ABSTRACT

A laser scanning unit includes a light source, a rotary polygon mirror to deflect a laser beam emitted from the light source, an f-theta lens to image the laser beam deflected from the rotary polygon mirror on a photoconductor, and a flat plate disposed between the light source and the photoconductor to correct a scanning line of the light source. The laser scanning unit can correct an inclination and/or a curvature of a scanning line caused by rotations of the rotary polygon mirror and the photoconductor and other working and assembling processes in order to minimize a deterioration in other performances, thereby allowing product quality to improve.

### CROSS-REFERENCE TO RELATED APPLICATIONS

This application claims priority under 35 U.S.C. §119(a) from Korean Patent Application Nos. 10-2006-087674 and 10-2006-104983, filed on Sep. 11, 2006 and Oct. 27, 2006, respectively, in the Korean Intellectual Property Office, the content of which is incorporated herein in their entireties by reference.

### BACKGROUND OF THE INVENTION

1. Field of the Invention

The present general inventive concept relates to an image forming apparatus, and more particularly, to a laser scanning unit to correct an inclination and/or a curvature of a scanning line, and an image forming apparatus having the same.

2. Description of the Related Art

A conventional electrophotography image forming apparatus is provided with a laser scanning unit to form an electrostatic latent image on a photoconductor.

FIG. 1 is a view schematically illustrating a conventional laser scanning unit which forms an electrostatic latent image on a plurality of photoconductors by using a single rotary polygon mirror.

As illustrated in FIG. 1, the laser scanning unit includes a plurality of light sources 1 and a rotary polygon mirror 2, so that it forms an electrostatic latent image on two different photoconductors 5a and 5b. However, as illustrated with a plurality of dotted lines in FIG. 1, scanning lines of laser beams which are imaged on the photoconductors 5a and 5b are gradually inclined with respect to ends of the photoconductors 5a and 5b, respectively. Accordingly, the laser scanning unit requires a means to correct the inclined image in order to produce a normal image.

FIG. 2 is a view schematically illustrating another conventional laser scanning unit having means to correct an inclination of a scanning line. As illustrated in FIG. 2, a scanning line-inclination correcting mirror 4 is disposed between an f-theta lens 3 and a photoconductor 5a to allow the scanning line-inclination correcting mirror 4 to move forward and backward with respect to a scanning direction to correct the inclination of the scanning line. Accordingly, when a plurality of light sources 1 are provided in the laser scanning unit of FIG. 2., the laser scanning unit of FIG. 2 includes a pair of laser scanning units having the same construction as that of the laser scanning unit of FIG. 1.

However, when the inclination of the scanning line is corrected by moving the mirror 4 forward and backward as described above, a laser beam may be displaced twice as much as the movement of the mirror 4. Accordingly, it is not easy to correct the inclination of the scanning line by a method such as an adjustment of a position or a reflective angle of the mirror. Accordingly, the adjustment of a position or a reflective angle of the mirror could result in a variable diameter of the laser beam, a linearity of the laser beam passing through the f-theta lens 3, etc., thereby causing image quality to deteriorate.

In contrast, Japanese patent publication Nos, 2005-265904 and 2004-070108 disclose tandem type scanning optical systems using a sub-scanning inclined-incident method, which to separate a laser beam by using a reflective mirror on an optical path of the laser beam reflected from a rotary polygon mirror while reducing the rotary polygon mirror in thickness, the laser beam incident onto and reflective from the rotary polygon mirror is to have a predetermined angle. In the tandem type scanning optical systems, a curvature of a scanning line is generated to be symmetrical to an up-and-down direction based on an optical path of a sub-scanning direction, regardless of the number or arrangement of imaging optical systems. Such a curvature of the scanning line is usually corrected by forming lenses of an imaging optical system in a non-symmetrical shape or an aspheric shape, eccentrically disposing or rotating some lenses of the imaging optical system, or deforming a reflective mirror disposed at the rear of the imaging optical system.

An optical path design for laser beams can make the curvature of the scanning line become zero, but the curvature of scanning line results from part tolerances or assembling errors in product fabrication. Accordingly, the curvature of the scanning line is corrected through additional apparatuses or methods as described above.

However, based on an optical path of a laser beam having a largest curvature of a scanning line, curvatures of other scanning lines at optical paths of a plurality of other laser beams are corrected. Accordingly, it is not easy to correct the curvature of the scanning line, which is formed from the plurality of other laser beams which project in various directions.

### SUMMARY OF THE INVENTION

The present general inventive concept provides a laser scanning unit having an improved construction to correct an inclination of a scanning line without a deterioration in other performances, such as a diameter of a laser beam imaged on a photoconductor, a linearity of laser beam, etc., and an image forming apparatus having the same.

The present general inventive concept also provides a laser scanning unit having an improved construction to correct a curvature of a scanning line caused by a plurality of laser beams diagonally incident onto a rotary polygon mirror, and an image forming apparatus having the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a laser scanning unit to correct an inclination of a scanning line, including a light source, a rotary polygon mirror to deflect a laser beam emitted from the light source, an f-theta lens to image the laser beam deflected from the rotary polygon mirror on a photoconductor, and a flat plate inclined disposed in a predetermined angle θ to a main scanning direction between the f-theta lens and the photoconductor to correct the inclination of the scanning line.

The flat plate may be inclined at a predetermined angle 90°−θ_{⊥} with reference to a scanning surface and may be formed of a transparent material having a predetermined thickness t and a predetermined refractive index n.

The predetermined angle θ of the flat plate may satisfy the following mathematic formula when a time required scanning a line on the photoconductor is represented as s.

$$0 < \vert n \cdot t \cdot sin {θ}_{⊥} \cdot cos {θ}_{⊥} \cdot ( \frac{1}{sin ( {θ}_{1} + θ ) \cdot \sqrt{{n}^{2} - {sin}^{2} {θ}_{⊥}}} ) - ( \frac{1}{sin ( {θ}_{2} - θ ) \cdot \sqrt{{n}^{2} - {sin}^{2} {θ}_{⊥}}} ) \vert < 3 \times Linear velocity of photoconductor \times s$$

The foregoing and/or other aspects and utilities of the present general inventive concept may also be achieved by providing a laser scanning unit, including at least two light sources, a rotary polygon mirror to deflect laser beams emitted from the light sources toward at least two photoconductors, respectively, at least two f-theta lenses disposed between the light sources and the photoconductors to image the laser beams deflected from the rotary polygon mirror on the photoconductors, respectively, and at least two flat plates inclined disposed in a predetermined angle θ to a main scanning direction between the f-theta lenses and the photoconductors to correct inclinations of scanning lines, respectively.

The flat plate may be inclined at a predetermined angle 90°−θ_{⊥} with reference to a scanning surface, and may be formed of a transparent material having a predetermined thickness t and a predetermined refractive index n.

The foregoing and/or other aspects and utilities of the present general inventive concept may be achieved by providing a laser scanning unit, including a light source, a rotary polygon mirror to deflect a laser beam emitted from the light source, and an f-theta lens to image the laser beam deflected from the rotary polygon mirror on a photoconductor. The f-theta lens may be disposed to produce a slope in a main scanning direction to correct an inclination of scanning line.

The foregoing and/or other aspects and utilities of the present general inventive concept may also be achieved by providing an image forming apparatus, including a photoconductor, and the laser scanning unit as described above to form an electrostatic latent image on the photoconductor.

The foregoing and/or other aspects and utilities of the present general inventive concept may also be achieved by providing a laser scanning unit capable of correcting a curvature of scanning line, including a plurality of light source, a rotary polygon mirror to deflect laser beams inclined incident from the light sources, an f-theta lens to image the laser beams deflected from the rotary polygon mirror on a photoconductor, and a flat plate disposed between the rotary polygon mirror and the f-theta lens to correct the curvature of a scanning line.

The flat plate may be inclined at a predetermined angle θ′ with reference to a scanning surface, and may be formed of a transparent material having a predetermined thickness t and a predetermined refractive index n.

The predetermined angle θ′ of the flat plate may satisfy the following mathematic formula,

$$\vert 0.8 \cdot L \cdot ( \frac{1}{cos {θ}_{s}} ) \cdot tan {θ}^{′} \vert \leq \vert \frac{t \cdot cos {θ}^{′} \cdot sin {θ}^{′}}{\sqrt{{n}^{2} - sin {θ}^{′}} \cdot cos ( {sin}^{- 1} \frac{sin {θ}_{d}}{n} )} \vert \leq \vert 1.2 \cdot L \cdot ( \frac{1}{cos {θ}_{s}} - 1 ) \cdot tan {θ}^{′} \vert$$

wherein a distance from the rotary polygon mirror to the flat plate and a time required to scan a line on the photoconductor are represented as L and s, respectively.

The foregoing and/or other aspects and utilities of the present general inventive concept may also be achieved by providing an image forming apparatus, including a photoconductor, a plurality of light source, and the laser scanning unit as described above to form an electrostatic latent image on the photoconductor.

The foregoing and/or other aspects and utilities of the present general inventive concept may also be achieved by providing a laser scanning unit including a light source to emit a laser beam, a photoconductor upon which the laser beam is incident to form an electrostatic latent image, and a flat plate disposed between the light source and the photoconductor at a predetermined angle to correct a distorted scanning line of the light source.

The laser scanning unit may further include a rotary polygon mirror to deflect the laser beam emitted from the light source, and an f-theta lens to image the laser beam deflected from the rotary polygon mirror on the photoconductor.

The flat plate may have a predetermined thickness t and a predetermined refractive index n to produce optical paths of the laser beam.

A difference in the optical paths may produce the distorted scanning line.

An angle of the flat plate with respect to a scanning surface may be adjusted to correct the distorted scanning line.

The foregoing and/or other aspects and utilities of the present general inventive concept may also be achieved by providing a method of correcting a scanning line of a laser beam, the method including emitting the laser beam through a flat plate to be incident on a photoconductor, and adjusting an angle of the flat plate with respect to a scanning surface.

The angle of the flat plate may satisfy the following mathematic formula,

$$\vert 0.8 \cdot L \cdot ( \frac{1}{cos {θ}_{s}} ) \cdot tan {θ}^{′} \vert \leq \vert \frac{t \cdot cos {θ}^{′} \cdot sin {θ}^{′}}{\sqrt{{n}^{2} - sin {θ}^{′}} \cdot cos ( {sin}^{- 1} \frac{sin {θ}_{d}}{n} )} \vert \leq \vert 1.2 \cdot L \cdot ( \frac{1}{cos {θ}_{s}} - 1 ) \cdot tan {θ}^{′} \vert$$

wherein the angle of the flat plate with respect to the scanning surface, a magnitude of the image angle, a distance from the rotary polygon mirror to the flat plate, a predetermined refractive index of the flat plate, and a time required to scan a line on the photoconductor are represented as θ′, θ_{d}, L, n, and s, respectively.

The angle of the flat plate may satisfy the following mathematic formula,

$$0 < \vert n \cdot t \cdot sin {θ}_{⊥} \cdot cos {θ}_{⊥} \cdot ( \frac{1}{sin ( {θ}_{1} + θ ) \cdot \sqrt{{n}^{2} - {sin}^{2} {θ}_{⊥}}} ) - ( \frac{1}{sin ( {θ}_{2} - θ ) \cdot \sqrt{{n}^{2} - {sin}^{2} {θ}_{⊥}}} ) \vert < 3 \times Linear velocity of photoconductor \times s$$

wherein the angle of the flat plate with respect to the scanning surface, a predetermined angle with respect to a main scanning direction, a predetermined thickness of the flat plate, a predetermined refractive index of the flat plate, a first angle formed by a first portion of the laser beam corresponding to a beam axis, and a second angle formed by a second portion of a beam corresponding to the beam axis, are represented as 90°−θ_{⊥}, t, n, θ₁, and θ₂ respectively.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view schematically illustrating a conventional laser scanning unit with two light sources;

FIG. 2 is a view schematically illustrating another conventional laser scanning unit having means to correct an inclination of a scanning line;

FIG. 3 is a view schematically illustrating a laser scanning unit having a flat plate to correct an inclination of a scanning line according to an exemplary embodiment of the present general inventive concept;

FIG. 4 is a top plan view illustrating a method of calculating an arrangement angle of the flat plate of FIG. 3;

FIG. 5 is a side elevation view of the flat plate of FIG. 3;

FIG. 6 is a view schematically illustrating a laser scanning unit having a flat plate to correct a curvature of a scanning line according to another exemplary embodiment of the present general inventive concept;

FIG. 7 is a top plan view illustrating a method of calculating an arrangement angle of the flat plate of FIG. 6;

FIG. 8 is a view illustrating a state in which flat plates and f-theta lenses are disposed, so that a plurality of laser beams do not interfere with one another;

FIG. 9 is a side elevation view of the flat plate of FIG. 6; and

FIG. 10 is a view schematically illustrating an image forming apparatus to which the laser scanning unit according to the above exemplary embodiments of the present general inventive concept are applied.

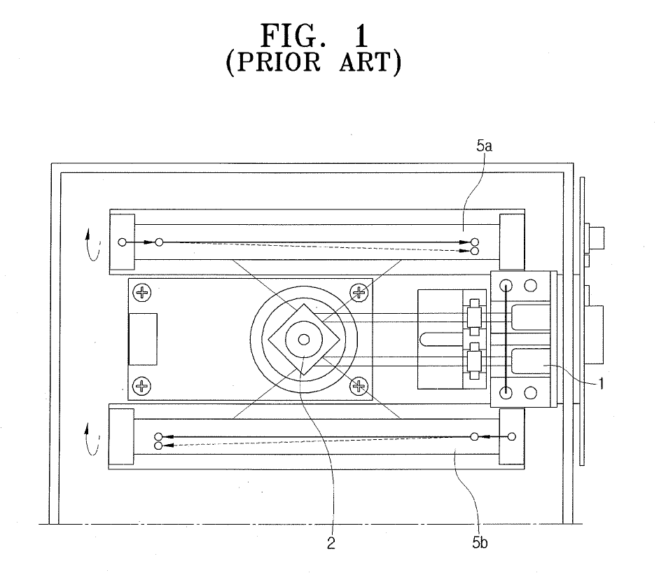

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

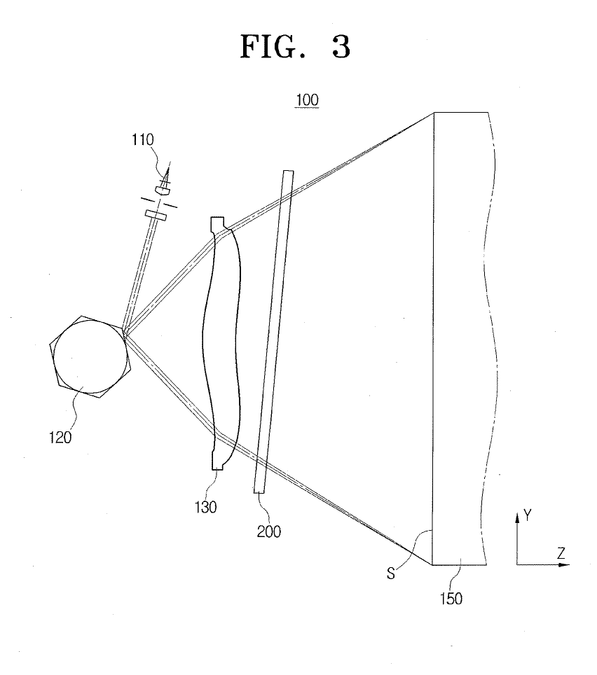

FIG. 3 is a view schematically illustrating a laser scanning unit 100 according to an exemplary embodiment of the present general inventive concept. The laser scanning unit 100 according to the exemplary embodiment of the present general inventive concept includes a light source 110, a rotary polygon mirror 120, an f-theta lens 130 and a flat plate 200.

Since constructions and functions of the light source 110, the rotary polygon mirror 120, and the f-theta lens 130 are conventional components of the present general inventive concept, detailed descriptions thereof will be omitted for clarity and conciseness.

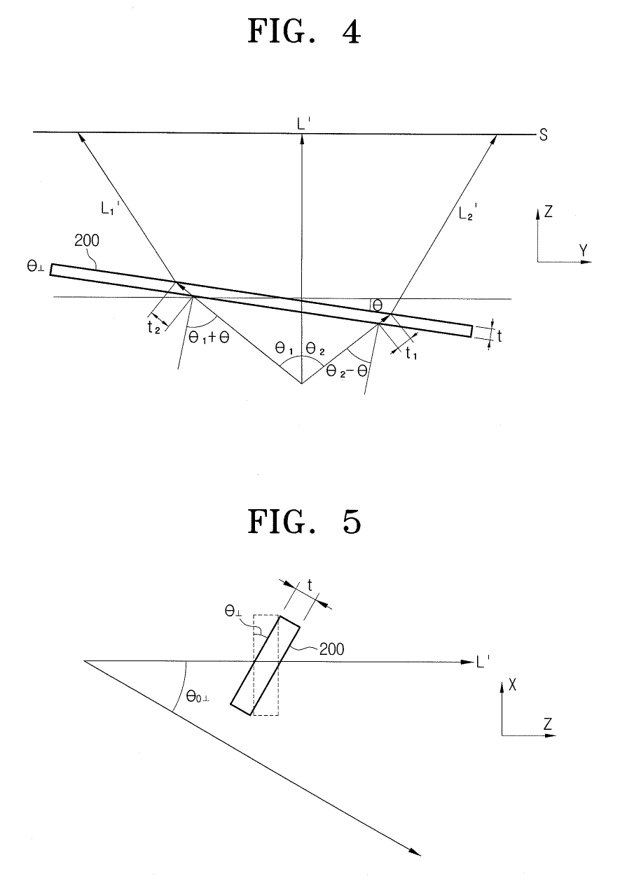

The flat plate 200 is disposed between the f-theta lens 130 and a photoconductor 150 to correct an inclination of a scanning line of a laser beam imaged on the photoconductor 150. As illustrated in FIG. 4, the flat plate 200 is diagonally disposed at a predetermined angle θ corresponding to a main scanning direction.

Hereinafter, a method of evaluating the predetermined angle θ of the flat plate 200 diagonally disposed as described above will be explained with reference to FIG. 4.

An image forming apparatus can be configured, so that according to a printing speed thereof, a rotating speed of the rotary polygon mirror 120 can be determined, and according to the rotating speed of the rotary polygon mirror 120, a linear velocity of the photoconductor 150 can be determined. Since the rotary polygon mirror 120 can rotate in a scanning direction and the photoconductor 150 can rotate in a vertical direction corresponding to the scanning direction, the laser beam imaged on a surface of the photoconductor 150 may generate an inclination of a scanning line. Such an inclination of the scanning line can be corrected by diagonally disposing the flat plate 200 at the predetermined angle θ to a light axis L′ in the main scanning direction between the f-theta lens 130 and the photoconductor 150.

If the flat plate 200 is diagonally disposed as described above, the laser beam may generate a difference in an optical path according to the angle θ of the flat plate 200 while passing through the flat plate 200. The optical path can be calculated by multiplying a refractive index by a thickness of a medium to be passed therethrough. Accordingly, a refractive index n and a thickness t of the flat plate 200 produce an optical path of the laser beam passing through a center of the flat plate 200 and arrive at n·t, and optical paths L₁′ and L₂′ of the laser beam passing through both ends of the flat plate 200 arrive at n·t₁ and n·t₂, respectively. Since the difference in the optical paths appears as an inclination of the scanning line on the surface of the photoconductor, the inclination of the scanning line can be corrected if the angle θ of the flat plate 200 is adjusted.

In addition, to prevent the laser beam imaged on the photoconductor from reflecting again and thus forming a ghost image on the surface of the photoconductor 150, as illustrated in FIG. 5, the flat plate 200 is disposed in a state inclined by a predetermined angle (90°−θ_{⊥}) with reference to a scanning surface S. An angle of the laser beam incident on the flat plate 200 is θ_{0⊥}.

Accordingly, the angle (θ) of the flat plate 200 satisfies the following mathematic formula 1 where a time s is required to scan a line on the photoconductor.

$$\begin{matrix}\begin{matrix}0 < \vert n \cdot t \cdot sin {θ}_{⊥} \cdot cos {θ}_{⊥} \cdot \\ ( \frac{1}{sin ( {θ}_{1} + θ ) \cdot \sqrt{{n}^{2} - {sin}^{2} {θ}_{⊥}}} ) -\end{matrix} \\ ( \frac{1}{sin ( {θ}_{2} - θ ) \cdot \sqrt{{n}^{2} - {sin}^{2} {θ}_{⊥}}} ) \vert < \\ 3 \times Linear velocity of photoconductor \times s\end{matrix} \qquad [ Mathematic formula 1 ]$$

The angle (θ) of the flat plate 200 can be calculated using the above mathematic formula 1. For instance, if a linear velocity of the photoconductor 150 is 70 mm/s, the time s required to scan a line is 43 μs, the incident angle θ_{0⊥} is 0°, a slope θ_{⊥} of the flat plate 200 is 10°, the thickness t of the flat plate 200 is 2 mm, and θ₁ and θ₂ are 30°, respectively, and an inclination of a scanning line caused by the linear velocity of the photoconductor 150 and the rotation of the rotary polygon mirror 120 is generated by a magnitude of approximately 30 μm.

Accordingly, when an angle (θ) of the flat plate 200, to correct the inclination of the scanning line caused by the linear velocity of the photoconductor 150 having the magnitude of approximately 30 μm, is calculated using the above mathematic formula 1, it is determined to have a value of 0.6°. Thus, if the flat plate 200 has a tilt to 0.6°, the inclination of the scanning line is calculated as a value reduced by a magnitude of approximately 30 μm as compared with the original state through the above mathematic formula 1, and is thus corrected.

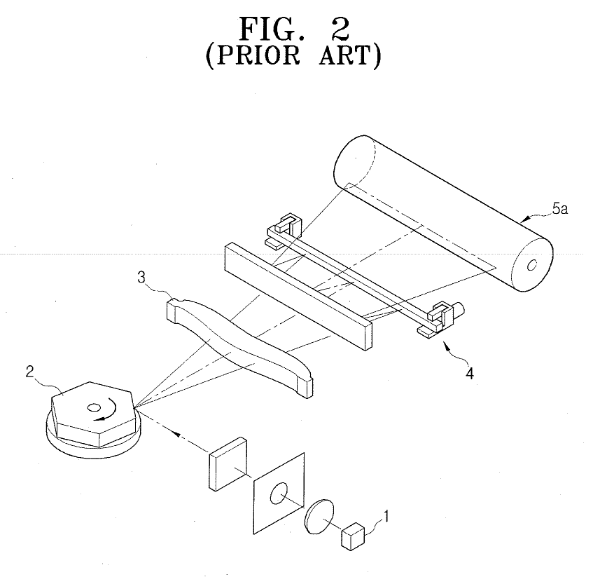

The above is also applicable to a laser scanning unit which uses more than two light sources and a single rotary polygon mirror to image laser beams on more than two photoconductors, as described in the description of FIG. 2. With reference to FIG. 3, the flat plate 200 may also be diagonally disposed between the photoconductors 150 and f-theta lenses 130, which form optical paths, to correct inclinations of scanning lines. Since a construction and an arrangement of the flat plate 200 are the same as those of the laser scanning unit 100 as described above with reference to FIG. 2, a detailed description thereof will be omitted for clarity and conciseness.

Also, although not illustrated, it is possible that instead of diagonally disposing the flat plate 200 as a separate part between the f-theta lens 130 and the photoconductor 150, the f-theta lens 130 itself, or a collimator lens (not illustrated) or a cylinder lens (not illustrated) may be diagonally disposed to correct an inclination of the scanning line as in the flat plate 200 of the laser scanning unit as described above.

As described above, when any one of various parts through which the laser beam emitted from the light source 110 is diagonally disposed by the predetermined angle to the main scanning direction, the inclination of the scanning line of the laser beam imaged on the photoconductor 150 can be corrected.

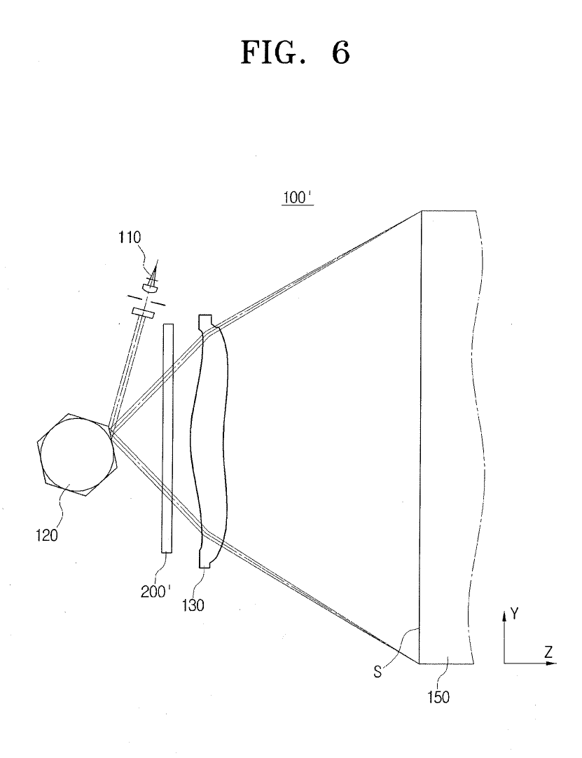

FIG. 6 is a view schematically illustrating a laser scanning unit 100′ according to another exemplary embodiment of the present general inventive concept. The laser scanning unit 100′ according to another exemplary embodiment of the present general inventive concept includes a light source 110, a rotary polygon mirror 120, an f-theta lens 130 and a flat plate 200′.

Since constructions and functions of the light source 110, the rotary polygon mirror 120, and the f-theta lens 130 are known components, detailed descriptions thereof will be omitted for clarity and conciseness.

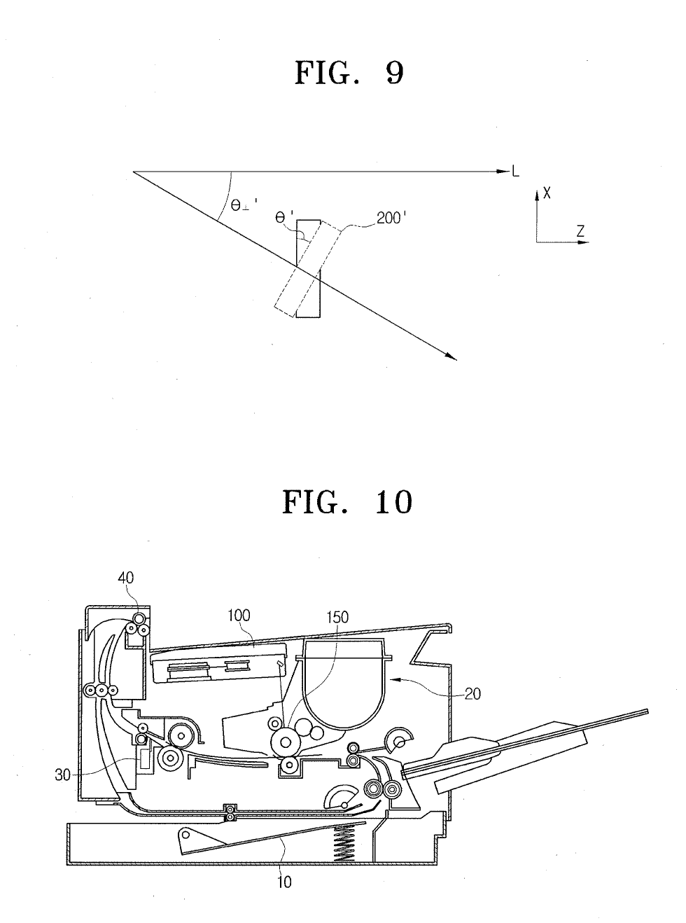

The flat plate 200′ is disposed between the rotary polygon mirror 120 and the f-theta lens 130 to correct a curvature of a scanning line of a laser beam imaged on a photoconductor 150. As illustrated in FIG. 9, the flat plate 200 is inclined at a predetermined angle (θ′) with reference to a scanning direction.

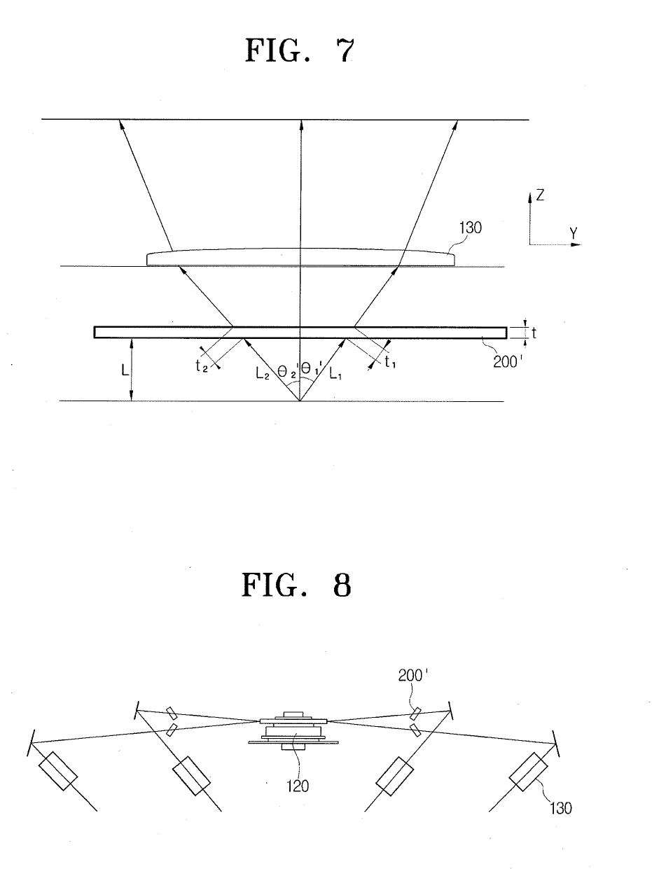

Hereinafter, a method of evaluating the predetermined angle (θ′) of the flat plate 200′ inclined as described above will be explained with reference to FIGS. 7 through 9.

An image forming apparatus can be configured so that according to a printing speed thereof, a rotating speed of the rotary polygon mirror 120 can be determined, and according to the rotating speed of the rotary polygon mirror 120, a linear velocity of the photoconductor 150 can be determined. If a plurality of light sources are provided, as illustrated in FIG. 8, the image forming apparatus can be configured so that laser beams emitted from the respective light sources are incident and are reflected at predetermined angles onto and from the rotary polygon mirror 120, and then are incident onto a plurality of photoconductors (not illustrated) without interfering with one another.

When the angles of the laser beams are inclined incident onto the rotary polygon mirror 120, an image angle, and a distance from the rotary polygon mirror 120 to the flat plate 200′ are represented as θ′_{⊥} (see FIG. 9), θ_{d} (+direction is θ′₁, and −direction is θ′₂), and L, respectively, a decenter is generated by an amount of

$$( \frac{L}{cos {θ}_{d}} ) \cdot tan {θ}_{⊥}^{′} .$$

The decenter is a variation in focus as a center of an optical axis onto which the laser beam is incident is moved. If a magnitude of the image angle θ_{d} is changed, a moving distance of the laser beam is changed and thus a magnitude of the decenter is changed. As a result, an incident height of the laser beam at both sides of the flat plate is different from that of a center thereof. At this time, a difference in the incident height of the laser beam between the center and the both sides of the flat plate corresponds to a length of the curvature of the scanning line.

When the laser beam having the curvature of a scanning line as described above passes through the flat plate 200′ while inclined at the predetermined angle, the curvature of the scanning line of the laser beam is corrected by a difference in the optical path generated due to the flat plate 200′ inclined at the predetermined angle, and the laser beam becomes incident into an optical system including the f-theta lens 130. A rotated angle θ′ of an xz plane of the flat plate, a refractive index n, and a thickness t of the flat plate can produce the magnitude of the decenter by the following mathematic formula 2.

$$decenter = \frac{t \cdot cos {θ}^{′} \cdot sin {θ}^{′}}{\sqrt{{n}^{2} - sin {θ}^{′}} \cdot cos ( sin \frac{sin {θ}_{d}}{n} )} \qquad [ Mathematic formula 2 ]$$

Accordingly, if the length of the curvature of the scanning line generated by the laser beam inclined incident onto the rotary polygon mirror 120 is set to the same value and a direction contrary to the inclination of the flat plate 200′, the curvature of the scanning line can be corrected.

When an image angle θ_{c} passing through the center of the flat plate 200′ is very close to 0 and an image angle passing through the both sides of the flat plate 200′ is θₛ, an inclined amount, that is, the rotated or inclined angle θ′ and the thickness t of the flat plate 200 satisfy the following mathematic formula 3.

$$\begin{matrix}\vert 0.8 \cdot L \cdot ( \frac{1}{cos {θ}_{s}} ) \cdot tan {θ}^{′} \vert \leq \\ \vert \frac{t \cdot cos {θ}^{′} \cdot sin {θ}^{′}}{\sqrt{{n}^{2} - sin {θ}^{′}} \cdot cos ( {sin}^{- 1} \frac{sin {θ}_{d}}{n} )} \vert \leq \\ \vert 1.2 \cdot L \cdot ( \frac{1}{cos {θ}_{s}} - 1 ) \cdot tan {θ}^{′} \vert\end{matrix} \qquad [ Mathematic formula 3 ]$$

The construction as described above may be applied to a tandem type laser scanning unit, which is used in the image forming apparatus described in the description of the related art, such as a color laser printer to form a color image by using different laser scanning units according to four colors, for example, cyan, magenta, yellow and black.

As illustrated in FIG. 10, an image forming apparatus to which the laser scanning unit constructed as described above is applied includes a medium supplying unit 10, a developing unit 20 having a photoconductor 150, a laser scanning unit 100 to form an electrostatic latent image on the photoconductor 150, a fixing unit 30, and a medium discharging unit 40.

Since the medium supplying unit 10, the developing unit 20, the fixing unit 30, and the medium discharging unit 40 are conventional components, detailed descriptions thereof will be omitted for clarity and conciseness.

The laser scanning unit 100 is provided with a flat plate 200 to correct an inclination of a scanning line of a laser beam imaged on the photoconductor 150 as described above.

Referring to FIG. 3, a magnitude of the inclination of the scanning line can be estimated using speeds of the rotary polygon mirror 120 and the photoconductor 150 determined according to a printing speed. Accordingly, if to offset the estimated magnitude of the inclination of scanning line, the flat plate 200 formed of a transparent material may be diagonally disposed in the predetermined angle θ calculated by the above mathematic formula 1 between the f-theta lens 130 and the photoconductor 150 to correct the inclination of scanning line.

Alternatively, the image forming apparatus of FIG. 10 may include the laser scanning unit 100′ of FIG. 6 provided with the flat plate 200′ to correct a curvature of the scanning line of a laser beam imaged on the photoconductor 150 as described above.

That is, a length of the curvature of the scanning line can be estimated by a slope of the laser beam incident onto the rotary polygon mirror 120. Accordingly, if the flat plate 200′ formed of a transparent material is diagonally disposed in the predetermined angle θ′ calculated by the above mathematic formula 3 between the rotary polygon mirror 120 and the f-theta lens 130 to generate an amount of the curvature of scanning line contrary to the estimated that, it is possible to correct the curvature of scanning line.

As apparent to the foregoing description, according to an exemplary embodiment of the present general inventive concept, the laser scanning unit and the image forming apparatus having the same can correct an inclination and/or a curvature of a scanning line caused by rotations of a rotary polygon mirror and a photoconductor and other working and assembling processes, in order to minimize performance deteriorations, such as a diameter change of a laser beam, a linearity deterioration of the laser beam, etc., thereby allowing product quality to improve.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A laser scanning unit, comprising:
a light source;
a rotary polygon mirror to deflect a laser beam emitted from the light source;
an f-theta lens to image the laser beam deflected from the rotary polygon mirror on a photoconductor; and
a flat plate disposed between the light source and the photoconductor to correct a scanning line of the light source.

2. The laser scanning unit according to claim 1, wherein the flat plate is inclined at a predetermined angle θ to a main scanning direction between the f-theta lens and the photoconductor to correct an inclination of the scanning line.

3. The laser scanning unit according to claim 2, wherein the flat plate is inclined at a predetermined angle 90°−θ_{⊥} with reference to a scanning surface.

4. The laser scanning unit according to claim 3, wherein the flat plate is formed of a transparent material having a predetermined thickness t and a predetermined refractive index n.

5. The laser scanning unit according to claim 4, wherein the predetermined angle θ of the flat plate satisfies the following mathematic formula:
$$0 < \vert n \cdot t \cdot sin {θ}_{⊥} \cdot cos {θ}_{⊥} \cdot ( \frac{1}{sin ( {θ}_{1} + θ ) \cdot \sqrt{{n}^{2} - {sin}^{2} {θ}_{⊥}}} ) - ( \frac{1}{sin ( {θ}_{2} - θ ) \cdot \sqrt{{n}^{2} - {sin}^{2} {θ}_{⊥}}} ) \vert < 3 \times Linear velocity of photoconductor \times s$$
wherein a time required to scan a line on the photoconductor, a first angle formed by a first portion of the laser beam corresponding to a beam axis, and a second angle formed by a second portion of the laser beam corresponding to the beam axis, are represented as s, θ₁, and θ₂, respectively.

6. The laser scanning unit according to claim 1, wherein the flat plate is disposed between the rotary polygon mirror and the f-theta lens to correct a curvature of the scanning line.

7. The laser scanning unit according to claim 6, wherein the flat plate is inclined at a predetermined angle θ′with reference to a scanning surface.

8. The laser scanning unit according to claim 7, wherein the flat plate is formed of a transparent material having a predetermined thickness t and a predetermined refractive index n.

9. The laser scanning unit according to claim 7, wherein the predetermined angle θ′ of the flat plate satisfies the following mathematic formula:
$$\vert 0.8 \cdot L \cdot ( \frac{1}{cos {θ}_{s}} ) \cdot tan {θ}^{′} \vert \leq \vert \frac{t \cdot cos {θ}^{′} \cdot sin {θ}^{′}}{\sqrt{{n}^{2} - sin {θ}^{′}} \cdot cos ( {sin}^{- 1} \frac{sin {θ}_{d}}{n} )} \vert \leq \vert 1.2 \cdot L \cdot ( \frac{1}{cos {θ}_{s}} - 1 ) \cdot tan {θ}^{′} \vert$$
wherein a magnitude of the image angle, a distance from the rotary polygon mirror to the flat plate, and a time required to scan a line on the photoconductor are represented as θ_{d}, L, and s, respectively.

10. A laser scanning unit, comprising:
at least two light sources;
a rotary polygon mirror to deflect laser beams emitted from the light sources toward at least two photoconductors, respectively;
at least two f-theta lenses disposed between the light sources and the photoconductors to image the laser beams deflected from the rotary polygon mirror on the photoconductors, respectively; and
at least two flat plates inclined disposed in a predetermined angle θ with reference to a main scanning direction between the f-theta lenses and the photoconductors to correct inclinations of scanning lines, respectively.

11. The laser scanning unit according to claim 10, wherein the flat plate is inclined at a predetermined angle 90°−θ_{⊥} with reference to a scanning surface.

12. The laser scanning unit according to claim 11, wherein the flat plate is formed of a transparent material having a predetermined thickness t and a predetermined refractive index n.

13. The laser scanning unit according to claim 12, wherein the predetermined angle θ of the respective flat plates satisfies the following mathematic formula:
$$0 < \vert n \cdot t \cdot sin {θ}_{⊥} \cdot cos {θ}_{⊥} \cdot ( \frac{1}{sin ( {θ}_{1} + θ ) \cdot \sqrt{{n}^{2} - {sin}^{2} {θ}_{⊥}}} ) - ( \frac{1}{sin ( {θ}_{2} - θ ) \cdot \sqrt{{n}^{2} - {sin}^{2} {θ}_{⊥}}} ) \vert < 3 \times Linear velocity of photoconductor \times s$$
wherein a time required to scan a line on the respective photoconductors, a first angle formed by a first portion of the laser beam corresponding to a beam axis, and a second angle formed by a second portion of the laser beam corresponding to the beam axis, are represented as s, θ₁, and θ₂, respectively.

14. A laser scanning unit, comprising:
a light source;
a rotary polygon mirror to deflect a laser beam emitted from the light source; and
an f-theta lens to image the laser beam deflected from the rotary polygon mirror on a photoconductor,
wherein the f-theta lens is disposed to produce a slope in a main scanning direction to correct an inclination of scanning line.

15. An image forming apparatus, comprising:
a photoconductor;
a light source;
a rotary polygon mirror to deflect a laser beam emitted from the light source;
an f-theta lens to image the laser beam deflected from the rotary polygon mirror on the photoconductor; and
a flat plate inclined at a predetermined angle θ with reference to a main scanning direction between the f-theta lens and the photoconductor to correct an inclination of a scanning line.

16. The image forming apparatus according to claim 15, wherein the flat plate is disposed at a predetermined angle 90°−θ_{⊥} with reference to a scanning surface.

17. The image forming apparatus according to claim 16, wherein the flat plate is formed of a transparent material having a predetermined thickness t and a predetermined refractive index n.

18. The image forming apparatus according to claim 17, wherein the predetermined angle θ of the flat plate satisfies the following mathematic formula:
$$0 < \vert n \cdot t \cdot sin {θ}_{⊥} \cdot cos {θ}_{⊥} \cdot ( \frac{1}{sin ( {θ}_{1} + θ ) \cdot \sqrt{{n}^{2} - {sin}^{2} {θ}_{⊥}}} ) - ( \frac{1}{sin ( {θ}_{2} - θ ) \cdot \sqrt{{n}^{2} - {sin}^{2} {θ}_{⊥}}} ) \vert < 3 \times Linear velocity of photoconductor \times s$$
wherein a time required to scan a line on the photoconductor, a first angle formed by a first portion of the laser beam corresponding to a beam axis, and a second angle formed by a second portion of the laser beam corresponding to the beam axis, are represented as s, θ₁, and θ₂, respectively.

19. An image forming apparatus, comprising:
a photoconductor;
a plurality of light source;
a rotary polygon mirror to deflect laser beams inclined incident from the light sources;
an f-theta lens to image the laser beams deflected from the rotary polygon mirror on the photoconductor; and
a flat plate disposed between the rotary polygon mirror and the f-theta lens to correct a curvature of a scanning line.

20. The image forming apparatus according to claim 19, wherein the flat plate is inclined at a predetermined angle θ′ with reference to a scanning surface.

21. The image forming apparatus according to claim 20, wherein the flat plate is formed of a transparent material having a predetermined thickness t and a predetermined refractive index n.

22. The image forming apparatus according to claim 21, wherein the predetermined angle θ′ of the flat plate satisfies the following mathematic formula:
$$\vert 0.8 \cdot L \cdot ( \frac{1}{cos {θ}_{s}} ) \cdot tan {θ}^{′} \vert \leq \vert \frac{t \cdot cos {θ}^{′} \cdot sin {θ}^{′}}{\sqrt{{n}^{2} - sin {θ}^{′}} \cdot cos ( {sin}^{- 1} \frac{sin {θ}_{d}}{n} )} \vert \leq \vert 1.2 \cdot L \cdot ( \frac{1}{cos {θ}_{s}} - 1 ) \cdot tan {θ}^{′} \vert$$
wherein a magnitude of the image angle, a distance from the rotary polygon mirror to the flat plate, and a time required to scan a line on the photoconductor are represented as θ_{d}, L, and s, respectively.

23. A laser scanning unit, comprising:
a light source to emit a laser beam;
a photoconductor upon which the laser beam is incident to form an electrostatic latent image; and
a flat plate disposed between the light source and the photoconductor at a predetermined angle to correct a distorted scanning line of the light source.

24. The laser scanning unit of claim 23, further comprising:
a rotary polygon mirror to deflect the laser beam emitted from the light source; and
an f-theta lens to image the laser beam deflected from the rotary polygon mirror on the photoconductor.

25. The laser scanning unit of claim 23, wherein the flat plate has a predetermined thickness t and a predetermined refractive index n to produce optical paths of the laser beam.

26. The laser scanning unit of claim 25, wherein a difference in the optical paths produces the distorted scanning line.

27. The laser scanning unit of claim 26, wherein an angle of the flat plate with respect to a scanning surface is adjusted to correct the distorted scanning line.

28. A method of correcting a scanning line of a laser beam, the method comprising:
emitting the laser beam through a flat plate to be incident on a photoconductor; and
adjusting an angle of the flat plate with respect to a scanning surface.

29. The method of claim 28, wherein the angle of the flat plate satisfies the following mathematic formula:
$$\vert 0.8 \cdot L \cdot ( \frac{1}{cos {θ}_{s}} ) \cdot tan {θ}^{′} \vert \leq \vert \frac{t \cdot cos {θ}^{′} \cdot sin {θ}^{′}}{\sqrt{{n}^{2} - sin {θ}^{′}} \cdot cos ( {sin}^{- 1} \frac{sin {θ}_{d}}{n} )} \vert \leq \vert 1.2 \cdot L \cdot ( \frac{1}{cos {θ}_{s}} - 1 ) \cdot tan {θ}^{′} \vert$$
wherein the angle of the flat plate with respect to the scanning surface, a magnitude of the image angle, a distance from the rotary polygon mirror to the flat plate, a predetermined refractive index of the flat plate, and a time required to scan a line on the photoconductor are represented as θ′, θ_{d}, L, n, and s, respectively.

30. The method of claim 30, wherein the angle of the flat plate satisfies the following mathematic formula:
$$0 < \vert n \cdot t \cdot sin {θ}_{⊥} \cdot cos {θ}_{⊥} \cdot ( \frac{1}{sin ( {θ}_{1} + θ ) \cdot \sqrt{{n}^{2} - {sin}^{2} {θ}_{⊥}}} ) - ( \frac{1}{sin ( {θ}_{2} - θ ) \cdot \sqrt{{n}^{2} - {sin}^{2} {θ}_{⊥}}} ) \vert < 3 \times Linear velocity of photoconductor \times s$$
wherein the angle of the flat plate with respect to the scanning surface, a predetermined angle with respect to a main scanning direction, a predetermined thickness of the flat plate, a predetermined refractive index of the flat plate, a first angle formed by a first portion of the laser beam corresponding to a beam axis, and a second angle formed by a second portion of a beam corresponding to the beam axis, are represented as 90°−θ_{⊥}, θ, t, n, θ₁, and θ₂ respectively.
